(19) United States
(12) Patent Application Publication
(10) Pub. No.: US 2024/0408514 A1
(43) Pub. Date: Dec. 12, 2024

(54) Cannabinoid Separation by Countercurrent Chromatography

(71) Applicant: Martha Knight, Washington, DC (US)

(72) Inventor: Martha Knight, Washington, DC (US)

(21) Appl. No.: 18/811,714

(22) Filed: Aug. 21, 2024

Related U.S. Application Data
(63) Continuation of application No. 17/435,691, filed on Sep. 1, 2021, now abandoned.
(60) Provisional application No. 62/813,023, filed on Mar. 2, 2019.

(51) Int. Cl. B01D 15/18; B01D 17/02; C07B 63/00

(52) U.S. Cl. CPC B01D 15/1807; B01D 17/0217; C07B 63/00

(57) ABSTRACT

A countercurrent chromatography method for separating cannabinoids using, for example, a solvent of hexane, methanol, ethyl acetate and water for separating THC and/or CBD, is provided.

### BACKGROUND OF INVENTION

Plants synthesize a variety of hydrocarbons composed of isoprene units (“Methods in Plant Biochemistry,” Dey & Harborne, eds., Academic, San Diego (1991) 7:519-536). Entities with lower chain lengths and varying numbers of cis and trans double bonds may be known as polyprenols, while some of those of longer chain length may be identified as rubbers (Dey & Harborne, 7:537-542). Synthesis of such hydrocarbons includes a number of pathway enzymes, such as, enzymes associated with synthesis of polyketides (PK) or of terpenoids, including synthases that form some of the starting materials, and prenyltransferases which catalyze sequential addition of hydrocarbon units to a starting material.

Cannabinoids have origins in both polyketide (phenolic) and terpenoid metabolism and often are considered terpenophenolics or prenylated polyketides. Cannabinoids of current medical significance are synthesized in appreciable amounts by essentially only two species of plants, Cannabis sativa and C. indica.

Cannabinoid biosynthesis occurs primarily in trichome glands of female flowers. In general, all plant parts can contain cannabinoids, except for the seeds. The highest cannabinoid concentration (in % of dry weight plant material) is found in the bracts of the flowers and fruits. Cannabis grown outdoors generally has lower levels of cannabinoids as compared to plants grown indoors. When grown under artificial, high yielding conditions, Cannabis flowering parts can comprise a resin content of up to 25-30% in the form of the acidic precursor, THCA.

Cannabinoids are formed by an initial three-step biosynthetic process: polyketide formation, prenylation and cyclization. Cannabinoids are produced by the Cannabis plant as carboxylic acids, where the substituent at position 2 is a carboxyl moiety (—COOH). Thus, substantially no neutral cannabinoids are found in fresh plants. The carboxyl group is lost with minimal encouragement as CO₂ under influence of, for example, heat or light, resulting in the corresponding neutral cannabinoid. That explains why many forms of Cannabis consumption include some form of heating of the material (for example, smoking, vaporizing, brewing a tea or making a baked product).

The cannabinoid polyketide precursor, olivetolic acid (OTA), is formed by an OTA synthase (OAS) or by coordinated, sequential action of an olivetol (OL) synthase (OS, also known as a tetraketide synthase (TS)), and an OTA cyclase (OAC), from starting materials, hexanoyl-CoA and malonyl-CoA.

OL is a decarboxylated OTA and is a diol. OS may produce OL or another product, such as, a linear tetraketide, since OL is not present in detectable amounts in C. sativa.

The second enzymatic step is prenylation of OTA with the terpenoid precursor, geranyl pyrophosphate (GPP) to form cannabigerolic acid (CBGA) by geranylpyrophosphate: olivetolate geranyltransferase, GOT, Fellermeier & Zenk, FEBS Lett 427:283-285, 1998.

In planta, GPP is formed by condensation of dimethylallyl pyrophosphate (DMAPP, also known as dimethylallyl diphosphate) and isopentyl pyrophosphate (IPP, also known as isopentyl diphosphate) by a GPPS.

GPP synthase (GPPS), which forms GPP, is found commonly in microbes, plants and animals. GPPS can be a homodimer or a heterodimer with a large subunit (LSU) and a small subunit (SSU). The SSU can be persuasive in directing or focusing catalytic activity, for example, to forming GPP.

Geranylgeranyl pyrophosphate (GGPP) synthase (GGPPS) is a common enzyme and generally is a homodimer. GGPPS can be a promiscuous enzyme that produces not only GGPP but GPP as well.

Oxidocyclase enzymes convert CBGA to, for example, Δ⁹-tetrahydrocannabinolic acid (THCA) or to cannabidiolic acid (CBDA).

Cannabinoids include cannabigerol (CBG): CBG monomethyl ether, cannabinerolic acid (CBA), cannabigerivarin (CBGV), cannabigerolic acid (CBGA), CBGA monomethyl ether, cannabigerovarinic acid (CBGVA), cannabichromene (CBC), cannabichromenic acid (CBCA), cannabichromevarin (CBCV), cannabichromevarinic acid (CBCVA), cannabidiol (CBD), cannabidiol monomethyl ether (CBDM), cannabidivarin (CBDV), cannabidiorcol (CBDO), cannabidivarinic acid (CBDVA), cannabinodiol (CBND), cannabinodivarin (CBNDV), Δ9-tetrahydrocannabinol (Δ9-THC or THC), Δ9-tetrahydrocannabivarin (Δ9-THCV), Δ9-tetrahydrocannabiorcol (Δ9-THCO), Δ9-tetrahydrocannabivarinic acid (Δ9-THVA), Δ9-tetrahydrocannabiorcolic acid (Δ9-THCOA), (−)-Δ8-trans-(6aR,10aR)-Δ8-tetrahydrocannabinol (Δ8-THC), (−)-Δ8-trans-(6aR,10aR)-tetrahydrocannabinolic acid (Δ8-THCA), (−)-(6aS,10aR)-Δ9-tetrahydrocannabinol ((−)-cis-Δ9-THC), cannabinol (CBN), cannabivarin (CBVN), cannabiorcol (CBRL), cannabinolic acid (CNA), CBN methylether (CBNM), (−)-(9R, 10R)-trans-cannabitriol (CBT), cannabielsoin (CBE), cannabicyclol (CBL), (+)-(1aS,3aR,8bR,8cR)-cannabicyclolic acid (CBLA), cannabichromanone (CBCN), cannabicoumaronone (CBCON), forms thereof, such as, those with substituents at different sites in the molecule, among other cannabinoids known in the art. The acronyms above and hereinbelow are not binding as the actual compounds are known.

Because of similarity of structure, molecular weight and so on, it can be difficult to isolate individual cannabinoids, remove a cannabinoid, purify larger amounts of a cannabinoid and so on from a mixture of cannabinoids.

Countercurrent chromatography (CCC) separates substances according to movement and affinity between a moving liquid phase through, about, within and so on, a stationary liquid phase, maintained in a path by, for example, hydrostatic or hydrodynamic equilibrium as a lengthy path, without use of a bulky, solid phase that requires regeneration or replacement. Separated compounds emerge from path end and are collected in fractions. In a known device, a process occurs in a coil of tubing in interleaved spirals with a continuous flow of solvent therethrough without a rotating seal (Ito (2005) Ewing's Analytical Instrumentation Handbook, 3^{rd} ed., Cazes, ed., Marcel Dekker, NY, p. 893-943) rotated about the coil axis around a central axis, the combination comprising a planetary centrifuge. Solvents are mixed in certain volume ratios to make two stable immiscible phases: one serves as a stationary phase (SP) and a certain fraction thereof remains in a coil under centrifugation at equilibrium, while a mobile phase (MP) is pumped through the tubing. separating analytes during centrifugation. Either phase can be utilized as an MP. CCC does not use expensive solid supports or column packing taking up volume. Higher SP volume holds more sample mass. Substances are separated by differences in partitioning or solubility of a cannabinoid in the SP and MP.

In CCC, a solvent system can be devised to fractionate a sample removing impurities or separating mixtures. Tubing coils or spools (multi-layer CCC columns or rotors) centrifuged at about 800 rpm using flow rates of about 2 ml or higher, retain about 60-80% of SP volume held by Archimedean screw force and centrifugal force field. Solvent systems can be organic-aqueous compositions of rapidly separating phases with high interfacial tension. Solvents can include, for example, hexane, t-butyl methyl ether, ethyl acetate, methanol, chloroform and the like.

CCC has been used to isolate natural products and products of organic synthesis reactions. More polar, larger molecules, such as, peptides, (Knight (2006) J. Chromatogr. A, 1151:148-152) are soluble in and partition well in heavy alcohol solvent systems.

CCC is distinct from and has advantages over other separation techniques. For example, CCC has better resolution than does centrifugal partition chromatography (CPC). The CCC apparatus is less complicated (for example, does not utilize rotary seals and plural cells as does CPC and hence does not experience rotary seal wear and/or fouling of the partitioning cells) and/or is less costly (CPC rotors generally are of metal, which can be heavy, whereas CCC rotors can be made of a ceramic, a plastic and so on, or made by a 3-D printing process). The solvent droplets of CPC are not as small as that of the mixing of CCC, resulting in lesser resolution and lower yield. Thus, solvents are not presumptively interchangeable for use in, for example, CCC and CPC. Each device and application require particular solvents be found beneficial for separating cannabinoids.

To enhance separation of, for example, relatively non-polar molecules of similar molecular weight, such as, THC and CBD, with shorter preparation time and/or higher yield using counter current chromatography, a new CCC method is needed.

However, doing so is not a mere exercise in scaling where measurements, for example, of tubing diameter, tubing length, centrifugation speed and so on are uniformly increased by a factor. A dedicated solvent system may be needed. Because of the plural factors that influence separation, plural factors need to be considered and scaling may not be linear across target molecules, the devices and methods.

Successful CCC separation of THC and CBD provides two reference standards that enable separation of any other cannabinoid. By systematic examination of separation conditions, for example, relative to those used to isolate THC and CBD, including solvent combinations, centrifugation parameters and so on, in a paradigm of CCC separation of a cannabinoid, any cannabinoid can be obtained in pure form.

### SUMMARY OF INVENTION

A method is described for separating cannabinoids, such as, tetrahydrocannabinol (THC) and cannabidiol (CBD) with countercurrent chromatography (CCC) using a solvent mixture comprising, for example, water and varying amounts of hexane, ethyl acetate (EtOAc), methanol (MeOH) and n-butanol (n-BuOH).

In embodiments, a two phase solvent system is used comprising water and varying amounts, and relative amounts, of hexane, ethyl acetate and methanol. In embodiments, the amount of hexane and of methanol is the same. That is, the ratio of the amount of hexane to the amount of methanol is 1. In embodiments, the amount of ethyl acetate and of water is the same. That is, the ratio of the amount of ethyl acetate (EtOAc) to the amount of water is 1. In embodiments, the amount of hexane and of methanol (MeOH) can range, in parts of the total, from about 0.1 to about 6. The solvent can be more polar where, in parts of the total, the amount of hexane and of methanol each is about 0.1, and the amount of ethyl acetate and of water each is about 1. The solvent can be more apolar wherein, in parts of the total, the amount of hexane and of methanol each is about 1 and the amount of ethyl acetate and of water each is about 0.1.

In embodiments, a solvent system to separate THC and CBD from a mixture of both is of the following reagents of hexane:ethyl acetate:methanol:water in the relative ratios, 6:1:6:1.

In embodiments, CCC conditions for separating any cannabinoid are determined and provided, including investigating partitioning of a cannabinoid between phases in a solvent mixture, using, for example, HPLC to identify and to measure cannabinoid in the phases to apply systematically altering centrifugation conditions to obtain separation and so on.

In embodiments, THC and/or CBD act as standards and controls, for example, of the method, and separation of other cannabinoids can be compared and contrasted with separation parameters of THC and CBD.

Additional aspects of the instant invention are provided in the figure and description below.

### BRIEF DESCRIPTION OF THE FIGURE

The following description of the figure and the respective drawing is a non-limiting example that depicts various embodiments that exemplify the present invention.

FIG. 1 is a depiction of a plot of UV (274 nm) absorbance of collected fractions (3 minutes, 6 ml) from a CCC run. Fractions containing THC and CBD were identified by high performance liquid chromatography (HPLC).

### DETAILED DESCRIPTION OF THE INVENTION

A detailed description and various embodiments of the present invention now will be given with reference to the following description and the accompanying figure. The present invention offers several advantages and improvements over the prior art and obviates shortcomings of the prior art. Description of specific embodiments of the invention are intended to be one of many possible embodiments of the invention and not intended to be interpreted as limiting or restricting the scope of the invention unless specified in the text. Unless otherwise defined. scientific terms used herein have a meaning as would be understood commonly by a person having ordinary skill in the art. It also is understood that plural reference is included, unless the context clearly dictates otherwise. For example, forms, such as, “a”, “an” and “the” are meant to include both the singular and plural as known in the art, unless the context dictates otherwise.

“About,” is an approximation relative to a certain value such that an amount or level of variability exists that is reflected, for example, in an error range of a value, or a deviation that provides a range of acceptable or usable values about that certain value, such as, ±10%, where the limits of the range are 10% less than the certain value, including the certain value and 10% greater than the certain value. Hence, as used herein, by reciting, “about 50,” it is understood that the value can range from 45 to 55. In embodiments, limits of the range are ±5%. A synonymous term includes, “essentially.”

“Substantial,” and grammatic forms thereof, are meant that, relative to a particular metric, an entity is considered to have that particular metric even if the entity metric is not the same as the particular metric but has a value at least 80% of the value of that the particular metric.

The subject invention can be operated at a variety of rotational speeds and under a variety of temperatures. The subject invention can be scaled for industrial level purification of cannabinoids.

In embodiments, the invention comprises a countercurrent chromatography support or disc, rotor or plate comprising a first and a second surface, wherein said first surface comprises a plurality of spiral channels or grooves to house a tubing, which channels or grooves are interweaved or interleaved to provide increased pitch of a spiral pathway on a disc or rotor. The first surface contains four or more radial channels to provide paths to course tubing into the rotor and to direct fluid from one spiral to another in a continuous spiral pathway. An increase in the pitch of spiral channels per disc increases stationary phase retention. The radial channels can have curved ends to minimize tubing having to traverse sharp bends, see, for example, U.S. Pat. No. 8,597,509.

Therefore, the four or more curved radial channels comprise a generally straight central or middle portion with curves at the termini, where curved includes a sinusoidal configuration, an “S” configuration, a reversed “S” configuration and so on to facilitate tubing placement and seating, for example, to avoid sharp bends and crimps in the tubing.

The curvature can be of a degree or extent that tubing is aligned to enter the appropriate spiral channel with minimal acute bends to form the interweaved spirals of tubing.

In embodiments, the countercurrent chromatography plate or disc is comprised of a plurality of interweaved or interleaved spiral channels. A disc or rotor can comprise 4, 6, 8, 12 or more interleaved spiral channels. The channels can be of any depth as a design choice, for example, about 4 cm, about 5 cm, about 6 cm, about 7 cm, about 8 cm, about 9 cm, about 10 cm or deeper.

Any known and/or commercially available tubing, of any composition as a design choice, of any size, as a design choice, can be used. Thus, channel width to fit tubing can be between from about 1.0 mm to about 10 mm, from about 1 mm to about 9 mm, from about 2 mm to about 8 mm, from about 2.5 mm to about 7.5 mm, about 5 mm, about 3.5 mm, about 2.5 mm and so on Radial channels can have increased dimensions to fit tubing pressed in the channels, and to fit tubing at each terminus to accommodate the curves.

Thus, a single tubing can be configured to form a series of interweaved spirals. For the purposes of the invention, interweaved is considered synonymous with interleaved, and also is synonymous with having a series of spirals in register, run in parallel or where a series of spirals is nested. The rotor contains two access points for ingress and egress of the tubing for a rotor of interest.

The spiral tube support (STS), rotor or disc can be formed from a variety of materials including. but not limited to, one or more of the following: (1) a nylon, (2) a plastic, (3) a polytetrafluoroethylene, (4) a polyvinyl chloride, (5) a polystyrene, (6) a polyamide, (7) a photopolymer, (8) a FULLCURE® (FULLCURE is a trademark of Objet Geometries Ltd, Rehovet, IL, and relates to a series of proprietary photopolymers suitable for 3-D printing) material, (9) a PolyJet 3D printer material, (10) a monomeric polymerizable powder, (11) a particulate comprising a metal or a metal composite. (12) a 3-D printable material and so on, or a combination thereof.

The aforementioned materials can be used to create a hard surface. To create a flexible structure, a material, such as, TangoBlack (a flexible 3-D printing elastomer) can be used in, for example, a PolyJet 3D printer.

The advantages of using an easily formed material are that a spiral tube support quickly and cost effectively may be fabricated and design changes can be accommodated easily. The prior art teaches construction of spiral tube supports by drilling, milling, machining and so on the spirals out of metal which is substantially more laborious to manufacture, but provides a more durable product, for use, for example, with certain solvents or at higher rotational speeds.

In embodiments, the rotor is formed using a three-dimensional prototyping or printing device (3-D printer) or by additive manufacturing. Examples of a machine that can be used to form the material for the design of the spiral support include, but are not limited to, a Sinterstation 2300 Plus (3-D Systems. Rock Hill, SC), an Eden500V (Objet Geometries, Rehovet, IL), or an EOS Precision (Krailling, DE). Generally, a polymerizable or fusible finely divided particulate or powder is distributed directedly in a thin layer on a platform, the distributed monomer or compound is exposed to a joining, solidifying, fusing or a polymerizing energy. a next layer of powder is applied directedly to the treated, solidified layer, and those processes are repeated until a final structure is obtained. The placing of powder on a solidified layer depends on the shape of the structure at that layer or level. The applied energy can be from a laser, an ultraviolet light, a heat source, a source of different wavelengths of electromagnetic radiation and so on.

A rotor of interest is generally cylindrical or circular in shape with an approximate diameter of at least about 14 cm, at least about 15 cm, or larger, at least about 26 cm, at least about 28 cm, or larger, such as, 22.5 cm. 23 cm. 25 cm and so on. and a height or depth of at least about 5 cm, at least about 11 cm, at least about 12 cm, at least about 13 cm, or taller.

Tubing can be laid from the bottom of the frame in a channel to pass across a break in the channel due to an intersecting radial pathway and is guided to fit into the continuing channel that spirals to the center. That is one spiral or one layer. The tubing is passed through the radial opening or path to the periphery and then passes through the outer circular channel of the next spiral. That is repeated for the number of spirals in the rotor, the when the tubing exits a radial to the outer channel, the tubing continues atop the spirals beneath. When the rotor is full, the tubing then is routed out an access port to the shaft and out of the centrifuge.

Tubing placement or winding can be in either the counterclockwise (CCW) direction in a rotor configured with the spiral direction to be CW from the center out. Conversely, winding can be clockwise (CW) for an oppositely configured rotor. The rotor rotation direction can be varied to enable and to maximize separation of a molecule or entity of interest.

Tubing in the channels may be pressed into a walled first surface space to accept plural layers of spirally oriented tubing, that is, to fit more layers in the rotor, support or frame. The tool can be used to guide or to push down tubing into the channels. That flattening of the tubing allows more layers of tubing in the rotor, which can provide for greater separation.

Thus, to enhance the flow path, the instant rotor enables a stacking of layers of interweaved spiral layers of tubing. Hence, an STS rotor can contain two layers, three layers, four layers, five layers, six layers, seven layers, eight layers, nine layers, ten layers, eleven layers, twelve layers, thirteen layers, fourteen layers, fifteen layers and so on of interweaved, nested spirals of tubing.

Larger bore tubing can be used to enhance tubing volume to enhance separation yield. Hence, for example, tubing inside diameter (ID) can be 1 mm or more, 1.2 mm or more, 1.4 mm or more, 1.6 mm or more, 1.7 mm or more, 1.8 mm or more, 1,9 mm or more, 2 mm or more, or larger in diameter. Tubing can have an ID of at least about 0.85 mm, at least about 0.9 mm, at least about 0.95 mm, at least about 1mm or larger.

Using a tubing with an inner diameter (ID) of about 1.6 mm, the tubing volume of the stack of layers or loops of tubing in a rotor can be at least about 450 ml, at least about 475 ml, at least about 500 ml, at least about 525 ml, or greater. Volume of fluid within a tubing can depend on the inner bore of the tubing, length of the tubing and so on, which can depend on rotor size.

Any known flexible tubing, such as, chromatography tubing, that is cannabinoid inert (does not interact or bind a cannabinoid), including, but not limited to: (1) TEFLON® (TEFLON® is a trademark of Chemours, Wilmington, DE and is a polytetrafluoroethylene thermoplastic polymer than can be constructed as a membrane or other forms), (2) fluorinated ethylene propylene (FEP), (3) stainless steel, (4) crenellated tubing, (5) convoluted tubing, (6) any commonly used flexible tubing, (7) a polyether ether ketone (PEEK), (8) a polytetrafluoroethylene (PTFE) or (9) any tubing that includes a combination of any of the aforementioned materials can be used as a design choice.

The solar and planetary shafts of the centrifuge can be oriented vertically so that rotor motion is in a horizontal plane. That orientation can enhance attaining phase equilibrium, such as, with viscous solvents, and provides equivalent gravitational force across the rotor. Alternatively, shafts can be horizontal and the CCC STS rotor moves in a vertical plane. That configuration can be more stable in mechanical design.

An accommodating centrifuge can have a revolution radius (distance between the solar axis and the planetary axis) from about 10 cm to about 13 cm. The revolution radius can be at least about 13 cm, at least about 14 cm, at least about 15cm, at least about 16 cm, or greater.

A centrifuge of interest can be operated at speeds, for example, about 1000 rpm or greater, about 1100 rpm or greater, about 1200 rpm or greater, about 1300 rpm or greater, or at higher speeds. The speed can be 950 rpm or lower, 900 rpm or lower, 850 rpm or slower, or slower.

With revolution radius incrementally increased from about 10 cm to about 13 cm, with a concomitant increase in rotor diameter from 17.5 cm to about 22.5 cm, and speed increased from 840 rpm to 1200 rpm, for example, the relative centrifugal field (RCF, a function of revolution radius and speed) increased from about 79 g to about 209 g, a greater than 2.5× increase. RCF can be increased about 2×, about 2.25×, about 2.75×, about 3×, about 3.5×, about 4× or more, by, for example, increasing revolution radius, rotor size and/or speed.

Relative centrifugal field can be calculated using the formula, RCF=11.17rx (RPM/1000)², where r is the revolution radius in centimeters.

A rotor can be constructed so that the lower face of the rotor that engages, abuts, sits on and the like, a shelf of a shaft of interest, can comprise parts which engage complementary sites of the shelf, an accommodating void, such as, a rectangular void on an inferior rotor face in register with and which engages a protruding bar structure of a shaft. Such an engaging affixes a rotor to a shaft.

The planetary shaft also can be designed to comprise a flare in size that increases in diameter in the direction away from the rotor to provide greater support of the larger and heavier rotors.

The rotor frame securing a rotor in a centrifuge can be machined from a strong, yet light, material, such as, a metal, such as, aluminum; can be molded, such as, a ceramic: can be printed using a 3-D printer using suitable particulate starting materials and so on, as known in the art, and as a design choice. At higher centrifuge speeds, metal may be preferred for constructing a rotor and a centrifuge.

At movable joints of the shafts, sealed, pre-lubricated or self-lubricating roller bearings can be employed, such as, at or in the juncture of the shaft and a shaft housing: at or in the juncture of a shaft and a shaft collar and so on. Such sealed bearings are suitable for high radial load and minimize angular misalignment at high speed. Increased rotor size and weight are better accommodated with such bearings.

Such devices provide a secure seating and connection of a rotor on a shaft, and enable free movement on the rotor frame about the central shaft.

A centrifuge of interest can comprise a power unit to provide the circular motion of the shafts, for example, an alternating current (AC) motor to enhance speed control. That provides controlled acceleration and deceleration, variable operations at low and high speeds, high torque and movement in either direction. The power unit can be attached directly to a shaft or spindle or can be attached indirectly to a shaft or a spindle, for example, by a belt, a chain and so on, as known in the art.

A centrifuge of interest can be in an enclosed cabinet and can comprise a refrigeration unit or device to lower the temperature under which separation occurs.

A centrifuge of interest can comprise a heat sink to control operating temperature.

The centrifuge of interest can accommodate greater fluid flow rate, greater than the currently standard rate of 2 ml/min, such as, greater than 2.25 ml/min, greater than 2.5 ml/min, greater than 2.75 ml/min, greater than 3 ml/min, greater than 3.5 ml/min, greater than 4 ml/min or higher flow rates. Fluid flow is attained and maintained using pumps known in the art.

The increased throughput of a centrifuge of interest enables separation of larger amounts of sample, such as, greater than 10 g of sample, greater than 20 g of sample, greater than 30 g of sample, greater than 40 g of sample, greater than 50 g of sample, greater than 60 g of sample, greater than 70 g of sample, greater than 80 g of sample, greater than 90 g of sample, greater than 100 g of sample, greater than 110 g of sample or larger amounts of sample.

Fitted tubing space, which is the ratio of space occupied by tubing in channels (rotor volume less the center shaft space) is increased by a factor of about 3.5 using larger bore tubing, deeper channels and so on. Fitted tubing space can be increased by a factor of 3, 4, 4.5, 5, 5.5, 6, 7, 8, 9, 10 or more.

Choice of a beneficial solvent system is essential to obtaining separation or isolation of a desired cannabinoid. A factor to be considered is determining the relative partition ratio (K) of an entity between two phases of a solvent system or mixture.

Values (presence and amount) to determine partition coefficients (K) of individual cannabinoids in a solvent can be measured by spectroscopy, HPLC, UV spectroscopy, fluorescence and other descriptive techniques as taught herein or as known in the art.

Solvent systems of different separation methods may be similar in composition. However, because the principle or mechanism of separation between or among techniques or technologies varies, what operates for one device does not guarantee operability of that solvent in another device. Hazecamp et al. (J Liq Chrom Rel Technol 27 (15) 2421-2439, 2004) teach CPC using a solvent comprising hexane with a yield of only 3.1%. US Publ. No. 2018/0036278 teaches a CPC process using a solvent of cyclohexane, heptane or octane. Any solvent system must be reviewed theoretically and actually tested in a CCC device.

The K (often ratio of concentration in SP to that in MP) of a target cannabinoid for facile separation can be about 0.3 or greater, about 0.325 or greater, about 0.35 or greater, about 0.375 or greater, about 0.4 or greater, about 0.425 or greater, about 0.45 or greater, about 0.5 or greater, about 0.55 or greater, about 0.6 or greater, about 0.65 or greater, about 3 or lower, about 2.75 or lower, about 2.5 or lower, about 2.25 or lower, about 2 or lower, about 1.75 or lower, about 1.5 or lower, or lower.

The K of a target cannabinoid for facile separation can be about 0.3 or lower, about 0.325 or lower, about 0.35 or lower, about 0.375 or lower, about 0.4 or lower, about 0.425 or lower, about 0.45 or lower, about 0.5 or lower, about 0.55 or lower, about 0.6 or lower, about 0.65 or lower, about 3 or lower, about 2.75 or lower, about 2.5 or lower, about 2.25 or lower, about 2 or lower, about 1.75 or lower, about 1.5 or lower, or lower.

A K value or about 0.5 predicts elution at about 0.5 column volumes. and a K value of about 2 predicts elution at about 2 column volumes. More than two column volumes could mean too much partitioning in one phase. A practical range of K values is 0.5 to 2, 0.5 to 1.75, 0.5 to 1.5 and so on as those values indicate early elution and separation between cannabinoids.

For adequate resolution of compounds to avoid overlap between or amongst adjacent collected fractions, the separation factor (S_{F}) of two entities, 1 and 2, according to the formula, α=K₂/K₁, wherein K₂>K₁, can be greater than 1.5, greater than 1.6, greater than 1.7, or more, although larger SF values could translate to a larger amount of fractions not containing a cannabinoid.

It can be beneficial if each phase of the solvent system be present in about equal volumes, but not necessary.

The lower or heavier phase of a two-phase solvent system can be introduced from the inner entry point. Alternatively, the upper or lighter phase of a two-phase solvent system can be pumped via the outer entry point with the appropriate orientation of the spiraling on the rotor, and hence, the tubing, and the appropriate direction of rotation by the centrifuge.

Using a four component solvent system of interest, generally the UP comprises hexane and most of the EtOAc and the LP generally comprises the MeOH and water. Using lower amounts of water can facilitate solvent removal of isolated fractions by evaporation.

In CCC, a cannabinoid can be present in an MP or in a retrieved fraction in an amount from 0.1 wt % to 95 wt % based on weight. A concentration of each of MP, SP and sample load is selected to maximize resolution of a population or of populations of molecules.

Hence, for example, an aliquot of powder (suspended or dissolved in a suitable fluid or liquid), an oil and the like, a preparation of purified cannabinoid, a plant extract (a solution obtained from a plant), a solution or supernatant of cell or tissue culture (for example, wild-type cells, modified plant cells, recombinant or genetically modified cells, whether Cannabis cells, plant cells, animal cells or microbes, where the tissues or cells are propagated or maintained in a nutrient liquid) and so on, essentially, any liquid sample suspected of containing a cannabinoid can be used in CCC. A powder or an oil, can be mixed, suspended or dissolved in the solvent system or in one component of the solvent system, such as, a suitable volume of MeOH (a sample in an organic liquid may need to be separated and suspended in MeOH) up to the calculated total amount of MeOH of the four-part solvent system of interest. Once fully in solution, any remainder of the calculated volume of MeOH is added, and then the calculated amounts of EtOAc, of hexane and of water are added to the sample-MeOH solution. The total volume of sample should not exceed 10% of the total volume of the rotor. If a sample is aqueous, the volume can be made up to the calculated volume of water. That preparation is injected into a stationary phase filled CCC tubing (coil). Centrifuge is turned on, mobile LP is introduced into the coil, at a rate, for example, of about 2 ml/min and fractions are collected for analysis to identify and to prepare pure preparations of a cannabinoid.

By that process each of CBD and THC was obtained from a mixture of those two cannabinoids as individual pure populations.

Thus, a sample can be any aliquot suspected of or which contains a cannabinoid, which can be a plurality of cannabinoids. As used herein, “extract.” is any substance which includes part of a plant or includes a liquid exposed to a plant, pressed plant material, which yield a liquid, such as, an oil, or which may be treated, such as, dried to form a paste or a powder, which is suspended or dissolved in a suitable liquid. An extract can be dried remains of plant material that is treated with a liquid which dissolves or suspends cannabinoids. The liquid generally is removed, often, as much as possible, to provide a sample, such as, an oil, with higher cannabinoid concentration. Thus, a liquid which has been in contact with a Cannabis plant, or part thereof, and hence, may or does comprise at least one cannabinoid can be used as a sample. A Cannabis tissue may steep in a liquid, be ground in a liquid, be macerated in a liquid, be boiled in a liquid, ground plant tissue may be combined with a liquid and so on.

A sample may comprise a cannabinoid preparation that is partially purified or pressed, such as, a brick or dried preparation of trichomes or resinous material from female flowers which can be contacted with a liquid to dissolve or to suspend a cannabinoid, any crude preparation obtained from Cannabis, a preparation separating solid material of Cannabis from liquid and so on.

An extract includes spent medium from a tissue culture or a cell culture. The tissue or cells can be Cannabis cells or transformed or recombinant cells manipulated to carry nucleic acid sequences that express a cannabinoid. Tissue, cells and particulates are removed and the medium is used for separating cannabinoids.

Spiral coiled tubing-rotors or spiral disc rotors can be operated at a speed and at an MP fluid flow rate as design choices, for example, which provide maximal separation of molecules with retention of the stationary phase SP. Hence, a flow rate can be about 2 ml/min or greater, about 2.25 ml/min or greater, about 2.5 ml/min or greater, about 2.75 ml/min or greater, or at greater flow rates. A centrifuge can be operated at a speed of about 700 rpm or more, about 800 rpm or more, about 1000 rpm or more, about 1200 rpm, or faster.

Spiral tubing support or spiral disk rotor designs of interest enable a means to chromatograph cannabinoids in an automated system. A laboratory instrument system can consist of a planet centrifuge with one or more STS rotors, a pump. a sample loading valve, a fraction collector and a system controller via computer or mobile phone app. Time of a run, with settings of rpm, pump solvent delivery selection and flow rates, automatic sample injection and fraction collection time can be programmed as a design choice. Rotor and components of interest provide a new useful separation means for materials of the Cannabis market.

After fractionating a composition (e.g., after a single run of a process herein), separated compounds may overlap partially in fractions between the concentrated peaks of separated cannabinoids, even in an amount that is not readily detectable. To recover more pure cannabinoid, fractions can be dried and resuspended in the four-part solvent system and can be used in a second run of a separation process of interest, and so on, until a more pure population of a particular cannabinoid is obtained. In embodiments, a second run can comprise a different solvent to facilitate or to enhance separation. That could result in a population with a purity of about 100%, greater than or equal to about 95%, greater than or equal to about 90%, greater than or equal to about 85% pure. By, “about,” herein is meant a metric that can vary up to 05% from a stated value, but no greater than an absolute, for example, about 100% cannot exceed 100%.

A fraction or a separated compound is removed from a rotor and can be subjected to further processing, such as, removal of solvent, replacement of diluent and so on, practicing known methods, such as, dilution, washing, centrifugation, evaporation, lyophilization and so on to obtain a purified preparation of a cannabinoid.

A fraction or a compound determined to be pure by an analytic technique can be subjected to routine processing for forming a commercial product.

A goal of the materials and methods of interest is to obtain a pure population of a cannabinoid, based on a difference of a property between or among cannabinoids, from populations of cannabinoids and any non-cannabinoids in a starting sample. Alternatively, a goal may be to remove a cannabinoid from a mixture, such as, removing THV from a mixture or extract, and using that mixture void of THC.

Materials for making a rotor or disc of interest are provided herein or are available commercially, for example, components can be machined: or components, such as, discs or rotors. can be purchased, for example, from CC Biotech (Rockville, MD). Planetary centrifuges can be made as known in the art or can be purchased. Tubing and chemical reagents, for example, to construct solvents, are available commercially.

Pure populations of cannabinoids, such as, of THC, or of CBD, can find use in the medical industry for various treatments as currently known in the art. Other cannabinoids of interest which can be purified by CCC include THCV, CBDV, CBG, CBC, CBN, THCA, CBDA, CBGA among others, which can or do have therapeutic value.

For example, a pure sample of a cannabinoid other than THC and CBD is mixed with a pure sample of THC and/or CBD and then that mixture is exposed to a CCC run practicing conditions usable for separation THC and CBD to ascertain whether the third cannabinoid is separable in a distinguishing fashion.

If separation is not workable, for example, two peaks are located very close to one another or overlap, centrifugation conditions systematically can be varied to optimize separation, such as, increasing MP injection rate, altering solvent composition, reversing direction of MP flow, reducing or raising temperature and so on.

Alternatively, the third cannabinoid is combined with a series of solvents to determine partition coefficients therein and selecting a solvent combination where, for example, K values are between 0.5 and 2. Then, the third cannabinoid is exposed to the multiphasic solvent based on the partition studies, which can include THC and/or CBD for reference, and centrifugation is allowed to proceed under common conditions, such as, at room temperature and at about 800 rpm.

The partition coefficients of the other cannabinoids can be determined in various solvent systems by, for example, HPLC analysis. A sample with multiple cannabinoids can be mixed in a CCC solvent composition (for example, see the table of Example 4) and the amount of each cannabinoid in the upper phase and in the lower phase can be determined by HPLC that shows all the peaks. The ratio of the peaks in the upper phase to the lower phase gives the K of each cannabinoid. Thus, the solvent system with desirable K's that show maximum differences indicate potential separation. Solvent systems can be chosen that separate a targeted cannabinoid within a suitable elution mode predicted by the K of that cannabinoid.

For example, solvent compositions 4 and 5 in the tables of Example 4 may better retain and separate CBDA and CBGA from CBD because 4 and 5 are more polar solvent systems. Solvent system 3, and modifications thereof can be used to separate more hydrophobic metabolites as well.

The hex-EtOAc-MeOH-water system can be modified to find K's that separate CBG, THCA, CBN from THC where the solvent system can be modified to be more hydrophobic or less polar conditions.

If two peaks are located very close to one another or overlap, the pure fractions can be recovered, and the reverse mobile phase can be used. Additionally, the solvent composition can be modified to separate closely eluted compounds.

More hydrophobic groups of metabolites, including more terpenes can be isolated by extraction with hexane and evaporating down to an oil. The partition coefficients can be studied by HPLC, MS or GC for the more hydrophobic compounds in solvent system 3 or 6, with modifications, if necessary. The goal is to find K values between 0.5 and 2.0.

The invention now will be exemplified in the following non-limiting examples.

### EXAMPLES

### Example 1

A spiral tube support frame was built by laser sintering using a Sinterstation 2300 Plus device. The prototyping machine formed the 3-D shapes of the spiral tube support and top, which were designed by a computer aided design (CAD) program. A monomeric powder, EOS Precision polyamide PA220, was used. Monomer was layered in the chamber and a laser moves over the surface in a programmed pattern. Then, another layer of powder in applied with a spreader followed by laser exposure. The formed rotor was washed with water to remove loose powder. The resulting hard white nylon composite rotor was stained green with a chemical resistant paint.

The top of the STS was prepared using the same method. A coating of TEFLON® was applied to the underside of the top to prevent abrasion of tubing in the assembled rotor.

A pressing tool was made by the same laser sintering process and consisted of a 15 cm diameter disk with a 2 cm center hole that fits around the shaft with four curved 5 cm extensions that fit into the radial grooves of the spiral tube support rotor.

Tubing, FEP SW #14 (Zeus Co.) 1.6 mm ID, 2.4 mm OD, was wound in the spiral tube support from the bottom and after every three layers, the tubing was pressed in the spiral channel with the pressing tool with moderate pressure and held with clamps for 15 min. About 10 layers of tubing fit in the rotor to give a total volume of about 135 ml.

The tubing in the assembled spiral tube support was filled with water. The rotor was suspended by a string from a screw inserted into the center shaft and weights were added to level the rotor. The weights are stainless steel shot balls 4.7 mm in diameter inserted into holes around the perimeter of the rotor and held in place with epoxy glue. Next, the screw on the string was removed. The tubing from inside the rotor was connected to two pieces of flow tubing with nuts, ferrules and a union outside the bottom and on the cover to 0.8 mm ID, 1.6 mm OD PTFE flow tubing, the rotor was mounted in the planetary centrifuge with the bearing blocks and the flow tubing was placed through the center axis shaft to the top of the planetary centrifuge and was clamped.

A 7.3 cm high and 17.5 cm OD 3-D printed spiral tube support and cover (dimensions without the gear) were used in a Centri-Chrom planetary centrifuge and another rotor of the same size was used in a P.C. Inc. planetary centrifuge. Additionally, a set of three rotors (10.4 cm high and 10.8 cm OD) were mounted in series on three separate planetary shafts with interconnected flow tubing in a Pharma-Tech Research Corp. planetary centrifuge. Finally, two rotors were built and mounted end to end on a single shaft with tubing connected by a union in a Shimadzu Corp. centrifuge.

A determination of the partition coefficient, K, is made by dissolving a small sample in a solvent system, shaking the mixture and measuring concentration of the sample in both phases after separation of the phases. That provides the ratio of upper to lower phase (Cᵤ/C₁). The mobile and stationary phase (Cₘ/Cₛ) can be the upper phase or the lower phase. Generally, the phase chosen as the MP is that giving a partition coefficient of about 0.5 to about 2.

For each compound, the experimental K (Kₑₓₚ) can be calculated by dividing the concentration in the SP (Cₛ) by the concentration in the MP (Cₘ). The K values can estimate elution order.

Typically, a sample is dissolved in a small volume (not more than 1/10 the total volume of the coil) of both phases and loaded into the coil already filled with SP. Centrifugation is begun and MP is pumped at. for example, about 2 ml/min. The effluent is passed through, if applicable, a UV detector with the direction upwards through the flow cell for a mobile upper phase and downwards for a mobile lower phase to clear phase droplets. Chromatography is allowed to proceed for two to three column volumes, during which time fractions are collected. When rotation is stopped, contents are pumped or pushed out with, for example, nitrogen or helium gas and fractions continue to be collected. If desired, for very slow eluting compounds, elution can be changed by making the SP the MP and allowing the compounds to elute through the other phase.

Fractions can be analyzed. for example, by HPLC, mass spectrometry, gas chromatography, polyacrylamide gel electrophoresis (PAGE) or other distinguishing technique to identify separated compounds. Fractions can be pooled and a desired compound isolated.

Three peptides were separated in a solvent system composed of a 1:1 (v/v) solution of sec-butanol-1% trifluoroacetic acid (“TFA”) in water with the lower aqueous phase as the mobile phase. Approximately 10 mg of each peptide was separated at a flow rate of 1 ml/min. Fractions were collected at two minute intervals and the elution profile for each peptide was determined by HPLC and absorption spectrophotometry.

The peptides were separated into pure fractions from mixtures.

Between runs, the coil can be cleaned by: (1) rinsing with water, (2) rinsing with acetone, and (3) drying the coil with a nitrogen stream.

### Example 2

### Solvent Systems

Solvent system components are mixed and are allowed to equilibrate to form two phases. An amount of a cannabinoid is added to equal volumes of the two phases in a total volume not to exceed about 10% volume of the coil.

Solvent systems giving different values of K for desired entities, such as, between 0.3 and 3, are selected for separation experiments. That allows a species of interest to elute after the solvent front and before 3 column volumes pass through the tubing or coil. One or more compounds can be retained in the SP.

K (Cᵤ/C₁) can be used to provide a ratio of concentrations of the substance in the upper to lower phase: C is concentration, for example, as determined by HPLC. The K value, as noted above, predicts compound elution relative to the volume in the CCC coil.

In CCC, K from a run is the ratio (Cₛ/Cₘ) in an SP to an MP which can be calculated from elution volumes. At K=1, a compound elutes at a column volume which is the total volume in a rotor excluding amount in flow tubing outside of the rotor. A phase that may be chosen as an MP is that giving a K closer to 1. In embodiments, elution volumes from about 0.3 to about 3 can comprise a zone of better resolution. K_{s/m} (SP/MP) calculated from elution of a compound is ratio of elution volume of the chromatographic peak (p) (retention volume) minus excluded volume of the column/rotor (m) to the total volume of the column/rotor (c) minus excluded volume of the column/rotor.

$$K = ( {V}_{p} - {V}_{m} ) / ( {V}_{c} - {V}_{m} )$$

For analysis of sample mixtures, efficiency of separation can be determined by use of the conventional gas chromatographic equation (Conway (1995) Chapter 1, ACS Symposium Series 593. “Modern Countercurrent Chromatography,” Conway et al., eds. American Chemical Society, Washington, DC, p 1-14,

$$N = {( 4 R / W )}^{2} .$$

Theoretical plates, TP or N, are calculated from shape of peaks. R is retention volume of a peak maximum and W is peak width expressed in the same units as that of R. For preparative separations, N may be up to 1000, but a more important relationship is resolution. Resolution between adjacent peaks is given by, where R values are retention volumes of the two species or populations:

$${R}_{S} = 2 ( {V}_{R 2} - {V}_{R 1} ) / ( {W}_{1} + {W}_{2} )$$

Using that equation and substituting each solute retention volume by the following:

$${V}_{R} = {V}_{m} + K {V}_{S}$$

where Vₘ cancels giving:

$${R}_{S} = 2 ( {K}_{2} - {K}_{1} ) {V}_{s} / ( {W}_{1} + {W}_{2} ) .$$

Thus, resolution is proportional to Vₛ and difference between K's. From high Vₛ typical of CCC, high resolution is possible even with low N values, which can be <1000.

Stationary phase (SF) retention measurement can be done by filling a rotor with one phase SP, beginning centrifugation and then pumping the other phase or MP through at a flow rate appropriate for a rotor and solvent system, usually at about 2 ml/min. When solvent front comes through, excluded SP represents excluded volume, Vₘ. Subtracting Vₘ from total column volume, V_{c}, yields SP volume, Vₛ. Phase retention is ratio of SP volume to total volume, Vₛ/V_{c}. High SF values above 80% for organic-aqueous solvent systems, relatively non-polar ones have been achieved with the rotors of interest.

### Example 3

A planetary centrifuge (Centri-Chrom, Inc., Buffalo. NY) was mounted with a spiral tubing support rotor (CC Biotech, Rockville, MD). Some experiments were performed with a rotor comprised of a 3-D printed circular framed body with grooves and radial channels holding FEP tubing of 1.6 mm OD in CW spiral layers. Total volume in the rotor was 90 ml.

The solvent comprised a 6:1:6:1 mixture of hexane, EtOAc, MeOH and water. The LP (MeOH rich) was eluted through the UP at 950 rpm and a flow rate of 2 ml/min.

As the above parameters were selected to separate THC and CBD, pure preparations of THC and CBD, mixed and introduced into the rotor, were separated successfully using CCC. THC and CBD have the same molecular weight.

### Example 4

Δ9-Tetrahydrocannabinol (THC) (1 mg/ml in methanol) and cannabidiol (CBD) (1 mg/ml methanol) were purchased from Cayman Chemical Co. (Ann Arbor, MI, US). A vial was opened and either 200 μl or 100 μl were aliquoted to Eppendorf tubes, and left open to air dry for a few hours or overnight.

The solvent systems noted in the table below were mixed by volume. The amounts of each combined are noted. The distribution of the volume of UP to LP usually is equal, unless noted.

Preliminary determinations were made with sec-butanol-water (1:1) and n-butanol-water (1:1), and then the following solvent systems were prepared as presented in the following tables. Usually the solvent systems settle or distribute to equal upper and lower phases unless noted in last column.

| Solvent system | | Equal phases |
|---|---|---|
| number | Components by volume | unless noted |
| 1 | sec-Butanol (BuOH)-1% trifluoroacetic | |
| | acid (TFA)/water (1:1) | |
| 2 | n-BuOH-1% aq. TFA (1:1) | |
| 3 | Hexane (Hex)-acetone-acetonitrile | UP 4.2 ml |
| | (ACN) (5:2:3) | LP 6.2 ml |
| 4 | Ethyl acetate (EtOAc)-n-BuOH-water | |
| | (2:1:3) | |
| 5 | Ethyl acetate-n-butanol-1% aq. TFA | |
| | (2:1:3) | |
| 6 | Hexane-ethyl acetate-methanol-water | UP 3 ml |
| | (6:1:6:1), 3 ml, 0.5 ml, 3 ml, | LP 4 ml |
| | 0.5 ml, respectively | |

The concentration of THC or of CBD in each phase of a solvent system was measured by UV spectral analysis or by HPLC.

For UV spectral analysis, to a dried sample were added 750 μl of the UP and 750 μl of the LP of a previously mixed solvent system, then 300 μl of each phase were removed and added to 750 μl of 50% aq. ethanol and the UV spectrum of that sample was read in a Cary spectrophotometer. The absorbance at 274 nm was determined and the ratio of UP to LP was calculated.

For HPLC analysis, 500 μl of each phase were added to the dried sample, and aliquots of 30 μl were injected into the Shimadzu 10Avp LC system. The peak heights of the chromatograms were compared to give the compound amount ratio of UP to LP. In HPLC, a column of C18 or of C8 S-5 μm (YMC, Allentown, PA, US) with 0.01% TFA, water and acetonitrile gradient or isocratic flow were used.

| | CBD | | | THC | | |
|---|---|---|---|---|---|---|
| Solvent system | Pk Hgt | Abs | K | Pk Hgt | Abs | K |
| Sec-BuOH-water | 54.7 | ✓ | 5.5 | 62.0 | ✓ | 9.4 |
| | 9.9 | ✓ | | 6.6 | ✓ | |
| Sec-BuOH-1% | 0.220 | ✓ | 2.7 | 0.829 | ✓ | 6.14 |
| TFA SS 1 | 0.082 | ✓ | | 0.135 | ✓ | |
| n-BuOH-water | | | | 0.630 | ✓ | 33 |
| | | | | 0.017 | ✓ | |
| n-BuOH-1% | 0.129 | ✓ | 8.6 | | | |
| TFA SS 2 | 0.015 | ✓ | | | | |
| Hex-acetone- | 283 | ✓ | 0.99 | 54.8 | ✓ | 0.56 |
| ACN SS 3 | 287 | ✓ | | 97.7 | ✓ | |
| EtOAc-n-BuOH- | 0.148 | ✓ | 4.2 | 0.262 | ✓ | 6.55 |
| water SS 4 | 0.035 | ✓ | | 0.040 | ✓ | |
| EtOAc-n-BuOH- | 0.132 | ✓ | 16.5 | 0.240 | ✓ | 10.9 |
| 1% TFA SS 5 | 0.008 | ✓ | | 0.022 | ✓ | |
| Hex-EtOAc- | 674 | ✓ | 0.5 | 1567 | ✓ | 2.4 |
| MeOH—H₂O SS 6 | 1340 | ✓ | | 664 | ✓ | |

In the table above are two rows of entries for each solvent system, data on the first line relates to that of the upper phase and data of the second line relates to that of the lower phase. The ratio is presented in the column headed, “K.” For each of CBD and THC are three data, height of the discernable peak in absorbance units (Pk Hgt) of the upper phase and of the lower phase, whether UV absorbance analysis was conducted (check mark) and K, the partition coefficient, by ascertaining the ratio of the upper phase peak absorbance value to the lower phase peak absorbance value. Two of the solvent systems, n-BuOH-water and SS2 yielded but a single peak, that of THC in the former system and that of CBD in the latter solvent system.

Of the solvent systems tested, non-aqueous solvent system 3(SS 3) had K values between 0.5 and 2.0. That means, using the K in CCC as meaning K=Cs/Cm (SP over MP) elution conditions of UP as the SP and LP as the MP, THC will elute at 0.56 or about a ½ column volume and CBD will elute later at 0.99 or about 1 column volume. Solvent system 6 had a similar result with K values between 0.5 and 2.4. CBD will elute at 2 or more column volumes whereas THC will elute first at about 0.5 column volume.

For other solvent systems, the compounds will elute much later and will be spread across many fractions rather that in fewer fractions, and may be less useful for separation of THC and CBD. A disadvantage of solvent system 3 is the high absorbance of acetone would make UV absorbance analysis of the fractions difficult.

Solvent system 6 can be modified using different volume ratios to adjust partitioning the analytes. The one prepared had K values of both analytes within a good chromatography range and different from each other with an a value or separation factor (ratio of K values) greater than 1.5. The volume ratios were optimized for primarily water-insoluble molecules.

With those adjustments, two solvent systems were used that could be used to separate CBD and THC from each other and from a plant extract.

With solvent system 1, CBD would elute at around 2 column volumes and THC would elute very much later. That could serve as a means for extraction of CBD from the other compounds. Solubility is not so high with solvent system 1. Substitutions could be made to increase solubility of compounds of interest and to derive better K values.

Technical details of CCC operation include flow tubing ( 1/16 in OD TEFLON®) connected in the top cover of the STS with 1.8 in OD FEP tubing with a compression fitting union (Idex Health and Science, Chicago, IL) that is filled in the rotor body. The other end of the tubing comes out the bottom through a hole and is connected to a union on the bottom surface and the flow tubing enters the rotor shaft and out below into the central axis. In the central axis, both tubes are inside a larger ID TYGON® (TYGON® is a registered trademark of Saint-Gobain Corporation, Solon, OH and relates to a range of plastic tubing) protective tubing containing some lubricating grease. Flow tubing passes out top of the centrifuge and is clamped to prevent twisting. A spiral tubing support rotor is counterbalanced on the opposite side of the rotor with metal rings equal in weight to the rotor and placed at the same height and same distance from the center axis of the centrifuge.

Solvent is pumped from a pump (DSP-20, D-Star Instruments, Manassas, VA.) Flow passes in a pump through a manifold with a 10 ml sample loop valve and another valve for helium for clearing rotor contents. Solvent flow then is connected to an in-flow tubing of a CCC instrument. Outflow from an instrument central axis goes to a fraction collector carrying glass test tubes (13×100 mm).

Elution mode for CCC can vary with flow going from top of a rotor downward or vice versa, and rotation of the rotor can be either CW or CCW, clockwise or counterclockwise. For example, U o T (U=upper phase: o=outer entry, bottom: T=tail to head end of column/rotor in CW rotation which means sample and mobile upper phase flow entered through the bottom of the rotor in tail to head direction) can result in high SP retention. In L i H elution mode, the lower phase was pumped into the top inner entry, in the head to tail direction, CW rotation.

### Example 5

A planet centrifuge (Conway Centri-Chrom, Buffalo, NY) mounted with a spiral tubing support (STS) rotor (CC Biotech) filled with 1.6 mm ID FEP tubing, pressed in at radials, has a total coil volume of about 90 ml.

Dried CBD (5×100 μg) was dissolved in 1.5 mls of methanol (1 mg/ml). Similarly, 6×100 μg aliquots of THC were dissolved in 1.5 ml of THC in methanol (1 mg/ml). The combined 3 ml of methanol containing CBD and THC were added to 3 ml hexane, 0.5 ml ethyl acetate and 0.5 ml water. The 2-phase sample solution was injected into the inlet flow tubing and a wash of 1 ml of each phase next was injected. The amount of each standard is around 2 mg.

Hexane (150 ml), ethyl acetate (25 ml), methanol (150 ml) and water (25 ml) were mixed in a separatory funnel and allowed to separate yielding an UP=150 ml and an LP=˜190 ml.

The tubing coil in the instrument was filled with upper phase. Sample was loaded as described above, then ˜950 rpm centrifugation was started and LP was pumped at a rate of 2 ml/min. Fractions of 3 min (6 ml) were collected. The elution mode was L i H. (CW centrifugation).

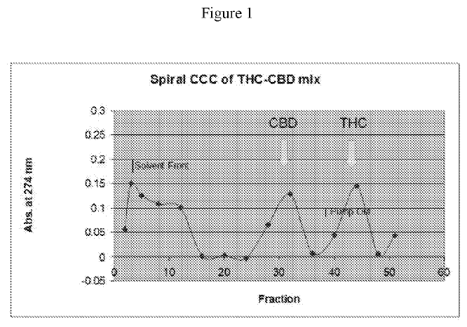

UP emerged until fraction #3, about 13 ml. That represents the excluded phase (Vₘ) and also, the SP which is about 85.6% retention. Elution continued until fraction #39, then the contents were pumped out of the coil with fractions collected without centrifugation. The UV absorbance at 274 nm was measured of every 4th fraction and plotted as shown in FIG. 1.

HPLC was conducted using a C-18 column (YMC, 5 μm, 0.49-15 cm) with a 0.1% aq. TFA (A) and 0.1% TFA/acetonitrile (B) gradient. A C-8,Propak YMC column, 25 cm long with 45% B isocratic conditions that eliminated instrument noise, also was used.

Fractions #5 and #12 did not have the standards. The peak at fraction #32 was identified as CBD and pooled fractions #42-46 contained THC.

The high retention of the upper, SP translates to efficient separation. Non-specific material emerged at the solvent front. The solvent system could be modified to change the K values having the peaks elute earlier or later depending on the degree of separation needed.

### Example 6

The method of Examples 2 and 4 is used to select a solvent for separating THCV by obtaining K values in various solvent systems. HPLC can be used to ascertain presence and amount of THCV.

A planetary centrifuge is mounted with tubing having an ID of 1.6 mm. Total volume in the rotor is 90 ml, as practiced in Examples 4 and 5.

The solvent identified by the partitioning study is loaded into the centrifuge. The centrifuge is operated at 950 rpm and a mobile phase flow rate of 2 ml/min.

A pure preparation of THCV of molecular weight 287 is obtained.

### Example 7

The method of Examples 2 and 4 is used to select a solvent for separating CBN by obtaining K values in various solvent systems. CBN presence and amount are determined by UV spectroscopy.

A planetary centrifuge is mounted with tubing that has an ID of 1.6 mm. Total volume in the rotor is 90 ml as practiced in Examples 4 and 5.

The solvent identified in the partitioning study is loaded into the tubing of the rotor. The LP centrifuge is operated at 950 rpm and an LP flow rate of 2 ml/min.

A pure preparation of CBN of molecular weight 310 is obtained.

All references cited herein, each herein is incorporated by reference in entirety.

Various modifications and changes can be made to the teachings herein without departing from the spirit and scope of the subject matter disclosed herein.

I claim:

1. A method of separating a cannabinoid from a mixture comprising applying a sample comprising said cannabinoid into a tubing of a countercurrent chromatography rotor of a planetary centrifuge, wherein said sample is dissolved in a solvent mixture which forms an upper phase and a lower phase in said tubing; exposing said sample to planetary rotation; and collecting fractions, wherein a fraction comprises said cannabinoid.

2. The method of claim 1, wherein said sample comprises tetrahydrocannabinol (THC), cannabidiol (CBD), tetrahydrocannabivarin (THCV), cannabidivarin (CBDV), cannabigerol (CBG), cannabichromene (CBC), cannabinol (CBN), tetrahydrocannabinolic acid (THCA), cannabidiolic acid (CBDA) or cannabigerolic acid (CBGA).

3. The method of claim 1, wherein said solvent mixture comprises hexane, ethyl acetate, methanol and water.

4. The method of claim 1, wherein said sample comprises a plant extract, a tissue culture supernatant or a cell culture supernatant.

5. The method of claim 3, wherein hexane and methanol are present in equal amounts.

6. The method of claim 3, wherein ethyl acetate and water are present in equal amounts.

7. The method of claim 3, wherein hexane comprises said upper phase.

8. The method of claim 1, wherein following applying said sample, lower phase is introduced to said rotor.

9. The method of claim 3, wherein relative to total, hexane comprises six parts.

10. The method of claim 3, wherein relative to total, water comprises one part.

11. The method of claim 3, wherein relative to total, hexane comprises six parts.

12. The method of claim 3, wherein relative to total, water comprises one part.

13. The method of claim 1, wherein said sample comprises THC and/or CBD.

14. The method of claim 1, wherein said sample is obtained from a Cannabis plant or part thereof.

15. The method of claim 1, wherein said sample comprises a plant extract.

16. The method of claim 1, wherein partitioning coefficient (K) of said cannabinoid is 0.5 or lower.
